(19) United States
(12) Patent Application Publication
(10) Pub. No.: US 2023/0165292 A1
(43) Pub. Date: Jun. 1, 2023

(54) FLUIDIZED-BED ELECTRIC COFFEE ROASTERS

(71) Applicant: KALDI COFFEE LAB INC, Seoul (KR)

(72) Inventor: Hyun-Pyo HONG, Seoul (KR)

(73) Assignee: KALDI COFFEE LAB INC, Seoul (KR)

(21) Appl. No.: 17/875,311

(22) Filed: Jul. 27, 2022

(30) Foreign Application Priority Data
Nov. 30, 2021 (KR) 10-2021-0167934

(51) Int. Cl. A23N 12/08

(52) U.S. Cl. CPC A23N 12/08

(57) ABSTRACT

A fluidized electric coffee roaster includes a housing; a fluidizing chamber having a predetermined volume into which raw coffee beans are introduced, discharged, and roasted; a heating unit communicating with a lower end of the fluidizing chamber; an air supply unit connected to the heating unit and supplying external air inside the housing to the heating unit; a raw coffee bean injecting unit connected to an upper end of the fluidizing chamber and allowing raw coffee beans to be injected into the fluidizing chamber from an outside; and a coffee discharging unit connected to a lower end of the fluidizing chamber and allowing roasted coffee to be discharged, wherein air heated by the heating unit is supplied to the lower end of the fluidizing chamber and is discharged to an upper end of the fluidizing chamber so that the raw coffee beans are circulated from a lower part of the fluidizing chamber to an upper part of the fluidizing chamber and roasted.

### CROSS-REFERENCE TO RELATED APPLICATIONS

The present application claims the right of priority to and the benefits of Korean Application No. 10-2021-0167934 having a filing date of Nov. 30, 2021, the content of which is hereby incorporated by reference in its entirety.

### TECHNICAL FIELD

The present invention relates to a coffee roaster, and more particularly, a fluidized electric coffee roaster, whereby heated air is supplied and discharged from a lower part of a fluidizing chamber to an upper part of the fluidizing chamber having a cylindrical structure in which raw coffee beans are injected. The raw coffee beans are circulated from the lower part of the fluidizing chamber to the upper part of the fluidizing chamber and roasted, thereby enabling roasting that maximizes the characteristics of the raw coffee beans while keeping the raw coffee beans from burning.

### BACKGROUND OF THE INVENTION

In general, three factors that determine the flavor of coffee are first, the type and quality of raw coffee beans; second, the degree of roasting of coffee; and third, a roasting method. In particular, the roasting method and the uniform roasting degree of raw coffee beans caused by the roasting method play a decisive role in flavor.

Specifically, coffee roasting refers to the process of making coffee beans by heat-treating raw coffee beans. Raw coffee beans do not have any taste or smell by themselves, but when the cell tissues of raw coffee beans are destroyed through the roasting process, various components (fat, sugar, acidity, caffeine, etc.) are activated and released to the outside. That is, because some components of raw coffee beans are strengthened and other components are weakened during the coffee roasting process, the taste and aroma of coffee beans may vary greatly depending on the roasting method.

A coffee roasting method according to the related art includes an electric method of roasting raw coffee beans while supplying hot air to the raw coffee beans using electric energy. Another method known in the art includes a gas method of roasting raw coffee beans by directly heating a rotating drum containing raw coffee beans with a heat source using gas energy.

Under the electric method and the gas method of roasting raw coffee beans according to the related art, as high temperature and dry heat are transferred to the raw coffee beans, moisture in the raw coffee beans evaporates, so that the raw coffee beans are roasted in a dried state. Moreover, roasting raw coffee beans under either of these conventional methods takes a lot of time and energy to reach the proper temperature such that the taste and flavor are deteriorated.

### BRIEF SUMMARY OF THE INVENTION

According to a preferred embodiment, the present invention provides a fluidized electric coffee roaster, whereby heated air is supplied and discharged from a lower part of a fluidizing chamber to an upper part of the fluidizing chamber having a cylindrical structure in which raw coffee beans are injected. The raw coffee beans are then circulated (fluidized) from the lower part of the fluidizing chamber to the upper part of the fluidizing chamber and roasted, thereby enabling roasting that maximizes the characteristics of the raw coffee beans while preventing the raw coffee beans from burning.

In yet another embodiment, the present invention also provides a fluidized electric coffee roaster, whereby external air is sprayed into a lower part of a fluidizing chamber at a high speed so that the fluidity of raw coffee beans is maintained even when the raw coffee beans are heavy, thereby enabling fluidized roasting.

In another embodiment, the present invention also provides a fluidized electric coffee roaster, whereby external air in which heated air discharged to an upper part of the fluidizing chamber is supplied to a lower part of the fluidizing chamber and preheated so that the electric energy of a heating unit can be saved.

According to an embodiment of the present invention, there is provided a fluidized electric coffee roaster including a housing; a fluidizing chamber having a predetermined volume into which raw coffee beans are introduced, discharged, and roasted; a heating unit communicating with a lower end of the fluidizing chamber; an air supply unit connected to the heating unit and supplying external air inside the housing to the heating unit; a raw coffee bean injecting unit connected to an upper end of the fluidizing chamber and allowing raw coffee beans to be injected into the fluidizing chamber from an outside; and a coffee discharging unit connected to a lower end of the fluidizing chamber and allowing roasted coffee to be discharged, wherein air heated by the heating unit is supplied to the lower end of the fluidizing chamber and is discharged to an upper end of the fluidizing chamber so that the raw coffee beans are circulated from a lower part of the fluidizing chamber to an upper part of the fluidizing chamber and roasted.

The fluidized electric coffee roaster may further include a flow auxiliary unit that is configured to be connected from the air supply unit to the lower end of the fluidizing chamber and allows external air to be directly supplied to the lower end of the fluidizing chamber and raw coffee beans, thereby flowing the raw coffee beans.

The fluidized electric coffee roaster may further include a dust collecting unit connected to the upper end of the fluidizing chamber that collects foreign substance in exhaust air discharged to an upper part of the fluidizing chamber, and a heat exchanging unit communicating with the dust collecting unit and providing a discharge flow path through which the exhaust air from which the foreign substances discharged from the dust collecting unit are removed, is discharged to the outside, wherein the heat exchanging unit allows external air inside the housing to be heat-exchanged by residual heat of the air discharged through the discharge flow path and then supplied to the lower end of the fluidizing chamber through the air supply unit.

The fluidizing chamber may include a chamber body having a rectangular cylindrical shape; an inclined surface configured in such a way that one side of a lower end of the chamber body is inclined toward the other side of the lower end of the chamber body; an air inlet, which is opened at the lower end of the chamber body with a cross-sectional area of a smaller size than the cross-sectional area of the chamber body and into which heated air is introduced from the air supply unit; a raw coffee bean inlet, which is opened at the upper end of the chamber body and through which raw coffee beans are introduced into the chamber body from the raw coffee bean injecting unit; a stirring plate, which is formed in a position spaced apart from the other side of the chamber body and into which heated air is introduced through the air inlet so that, when the raw coffee beans injected into the vicinity of the inclined surface of the chamber body are fluidized, an agitation layer of the raw coffee beans stacked inside the lower end of the chamber body does not collapse; a diffusion slot, which is located in the air inlet and in which heated air flowing into the lower end of the chamber body through the air inlet is diffused into the interior of the chamber body and simultaneously straightness is maintained; an air outlet, which is opened at one side of the upper end of the chamber body and in which heated air introduced into the chamber body is discharged to the dust collecting unit; and a coffee outlet, which is formed to extend to an opening formed in the lower part of the inclined surface at a predetermined angle and through which coffee roasted in the chamber body is discharged to the outside.

The flow auxiliary unit may include a booster pipe branching from a duct between the air supply fan of the air supply unit and the heating unit to the air inlet of the fluidizing chamber, and an on/off valve connected to the booster pipe and controlled.

The dust collecting unit may include an air outlet pipe communicating with the fluidizing chamber; a dust collector, which has a cylindrical structure and through which the air outlet pipe is connected to the upper end of one side of the dust collector and allows foreign substance having a high specific gravity to be dropped downwards when the exhaust air including the foreign substances is introduced; and an air moving pipe, which extends from the upper end of the dust collector to the heat exchanging unit and allows the exhaust air to be moved from the dust collector to the heat exchanging unit.

The heat exchanging unit may include a corrugated pipe, which is located in the lower chamber in a zigzag manner and has one end communicating with the air moving pipe of the dust collecting unit and allows the residual heat of the exhaust air to be dispersed into the inner space of the housing and the external air inside the housing to be heat-exchanged; and an exhaust fan, which is connected to the other end of the corrugated pipe and allows the exhaust air moved through the fluidizing chamber, the dust collector and the corrugated pipe to be discharged to the outside.

### BRIEF DESCRIPTION OF THE DRAWINGS

FIG. 1 is a perspective view illustrating a fluidized electric coffee roaster in accordance with the principles of a preferred embodiment of the present invention;

FIG. 2 is a perspective view illustrating the internal configuration of the coffee roaster of FIG. 1 in accordance with the principles of the preferred embodiment;

FIG. 3 is a cross-sectional view of the coffee roaster of FIG. 2 in accordance with the principles of the preferred embodiment;

FIG. 4 is a view illustrating the configuration of a lower chamber of the coffee roaster of FIG. 2 in accordance with the principles of the preferred embodiment;

FIGS. 5 and 6 are a perspective view and a cross-sectional view illustrating a fluidized chamber of the coffee roaster of FIG. 2, respectively, in accordance with the principles of the preferred embodiment;

FIG. 7 is a view illustrating a state in which raw coffee beans injected into the fluidized chamber of FIG. 3 are fluidized and roasted by heated air of a heating unit in accordance with the principles of the preferred embodiment;

FIG. 8 is a view illustrating a state in which, when raw coffee beans injected into the fluidized chamber of FIG. 3 are heavy, external air is added and the raw coffee beans are fluidized and roasted in accordance with the principles of the preferred embodiment; and

FIG. 9 is a view illustrating a flow auxiliary unit of the roaster as depicted in FIG. 8 in accordance with the principles of the preferred embodiment.

### DETAILED DESCRIPTION OF THE INVENTION

Hereinafter, the present invention will be described more fully with reference to the accompanying drawings, in which exemplary embodiments of the invention are shown.

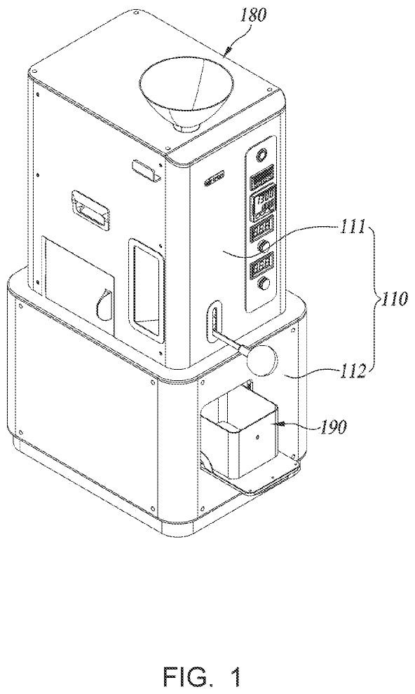

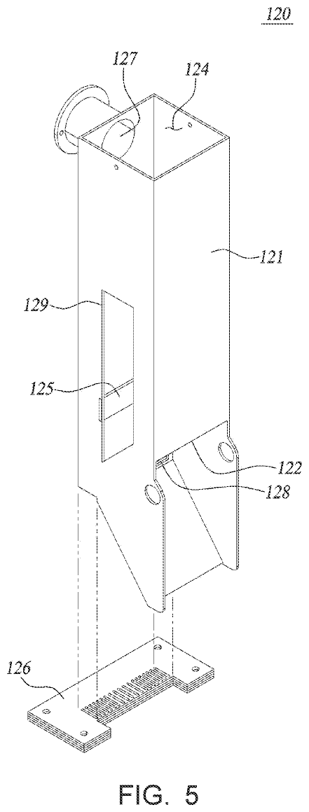

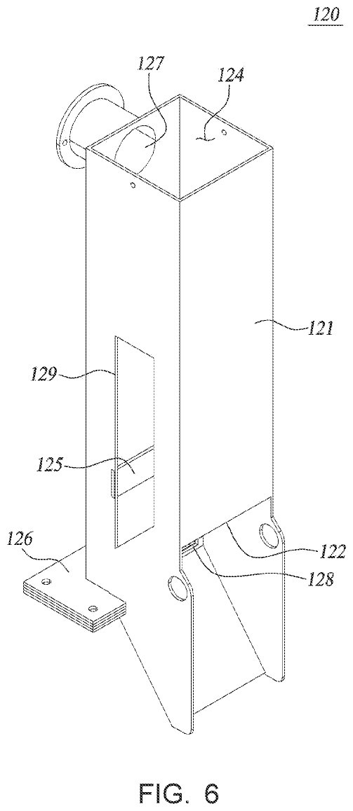

As illustrated in FIGS. 1 through 9, a fluidized electric coffee roaster according to a preferred embodiment of the present invention includes a housing 110 having an upper chamber 111 and a lower chamber 112, a fluidizing chamber 120 disposed in the upper chamber 111 and having a predetermined volume into which raw coffee beans are put, discharged and roasted, a heating unit 130 disposed in the lower chamber 112 and communicating with a lower end of the fluidizing chamber 120, an air supply unit 140, which is located in the lower chamber 112 and configured to be connected to the heating unit 130 and in which, after external air inside the lower chamber 112 is heated through the heating unit 130, heated air is supplied to the lower end of the fluidizing chamber 120 and is discharged to an upper end of the fluidizing chamber 120.

The air supply unit 140 is supplied with heated air to the lower part and discharged to the upper part, so that raw coffee beans are circulated from a lower part to an upper part of the fluidizing chamber 120 and roasted. A flow auxiliary unit 150 is connected from the air supply unit 140 to the lower end of the fluidizing chamber 120 and allows external air inside the lower chamber 112 to be directly injected into the lower end of the fluidizing chamber 120, such that when the raw coffee beans are heavy, it flows the raw coffee beans together with heated air. A dust collecting unit 160, which is located in the upper chamber 111, is configured to be connected to the upper end of the fluidizing chamber 120 and collects foreign substances in exhaust air discharged to the upper part of the fluting chamber 120. A heat exchanging unit 170, which is located in the lower chamber 112, communicates with the dust collecting unit 160, provides a discharge flow path through which the exhaust air from which the foreign substances discharged from the dust collecting unit 160 are removed, and is discharged to the outside of the lower chamber 112 to allow external air of the lower chamber 112 to be heat-exchanged by residual heat of the exhaust air so that when heated air is supplied to the lower end of the fluidizing chamber 120 through the air supply unit 140, electric energy consumption of the heating unit 130 can be saved. A raw coffee bean injecting unit 180, which is located outside the upper chamber 111, is configured to be connected to the upper end of the fluidizing chamber 120 to allow the raw coffee beans to be injected into the fluidizing chamber 120 from the outside. A coffee discharging unit 190, which is disposed in the lower chamber 112, is configured to be connected to the lower end of the fluidizing chamber 120 so that roasted coffee can be discharged.

As shown in FIG. 1, the housing 110 that is a housing unit for providing an upper chamber 111 and a lower chamber 112 for the components to be installed, is configured such a way that frames of the upper chamber 111 and the lower chamber 112 are detachable by a cover panel so that installation and maintenance of the components is facilitated.

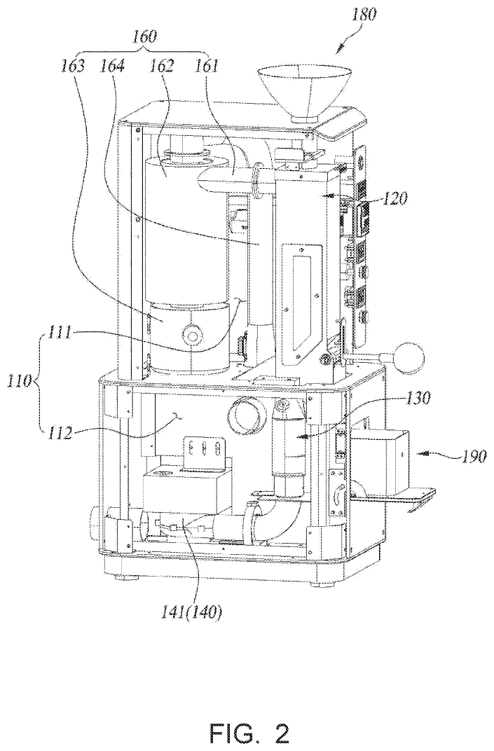

In FIGS. 2-3 and 5-9, it is shown that the fluidizing chamber 120 is a roasting chamber located in the upper chamber 111 that has a predetermined volume into which raw coffee beans are introduced, discharged, and roasted. The fluidizing chamber 120 includes a chamber body 121 having a rectangular cylindrical shape; an inclined surface 122 configured such a way that one side of a lower end of the chamber body 121 is inclined toward the other side of the lower end of the chamber body 121; an air inlet 123, which is opened at the lower end of the chamber body 121 with a cross-sectional area of a smaller size than the cross-sectional area of the chamber body 121 and into which heated air is introduced from the air supply unit 140; a raw coffee bean inlet 124, which is opened at the upper end of the chamber body 121 and through which raw coffee beans are injected into the chamber body 121 from the raw coffee bean injecting unit 180; a stirring plate 125, which is formed in a position spaced apart from the other side, which is the opposite surface of the inclined surface 122 of the chamber body 121, into which heated air is introduced through the air inlet 123 so that, when the raw coffee beans injected into the vicinity of the inclined surface 122 of the chamber body 121 are fluidized, an agitation layer of the raw coffee beans stacked inside the lower end of the chamber body 121 maintains an angle of repose that can be stabilized without collapsing to a predetermined height, thereby maximizing agitation and roasting effects; a diffusion slot 126, which is located in the air inlet 123 and in which heated air flowing into the lower end of the chamber body 121 through the air inlet 123 is uniformly diffused into the interior of the chamber body 121 and simultaneously straightness is maintained, thereby uniformly fluidizing the raw coffee beans and maximizing stir-ability and roasting effects; an air outlet 127, which is opened at one side of the upper end of the chamber body 121 and in which heated air introduced into the chamber body 121 is discharged to the dust collecting unit 160; and a coffee outlet 128, which is formed to extend to an opening formed in the lower part of the inclined surface 122 at a predetermined angle and through which coffee roasted in the chamber body 121 is discharged to the outside.

Here, the fluidizing chamber 120 enables the installation and configuration of the inclined surface 122, the stirring plate 125, and the diffusion slot 126, etc., through the chamber body 121 having a rectangular cylindrical shape. Thus, it is not necessary to float the raw coffee beans as high as in a fluidized bed according to the related art, so that stir-ability can be improved using low air pressure and energy, and the diffusion of conductive heat between raw coffee beans is allowed, resulting in maximization of the roasting effects.

On the other hand, preferably, the fluidizing chamber 120 further includes a penetration hole 129, which is disposed at one side of the chamber body 121 and through which the roasting situation of the raw coffee beans can be observed with the naked eyes from the outside on one side of the chamber body 121 to visually observe the roasting state of raw coffee beans from the outside.

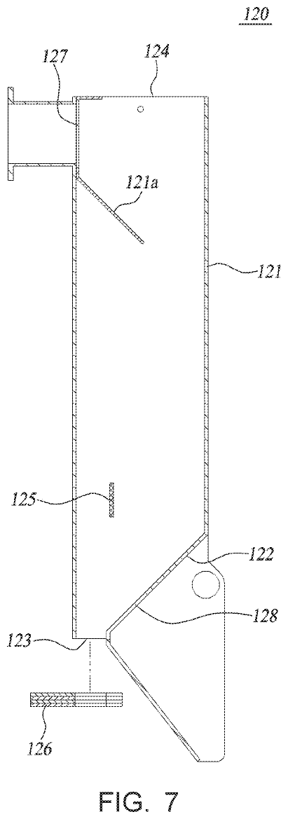

In addition, as shown in FIGS. 7-9, the fluidizing chamber 120 may further include an inclined plate 121a for dropping, which allow the raw coffee beans to drop near the inclined surface 122 when the raw coffee beans are introduced from the raw coffee bean inlet 124 to the lower end of the chamber body 121 at the upper end of the chamber body 121. After the raw coffee beans are concentrated near the inclined surface 122 by an inclined plate 121a for dropping and the raw coffee beans on the opposite side of the inclined surface 122 are moved upward by the heated air flowing in through the air inlet 123, the raw coffee beans are dropped into the inclined surface 122 in a higher position than the stirring plate 125 and thus, stir-ability can be enhanced.

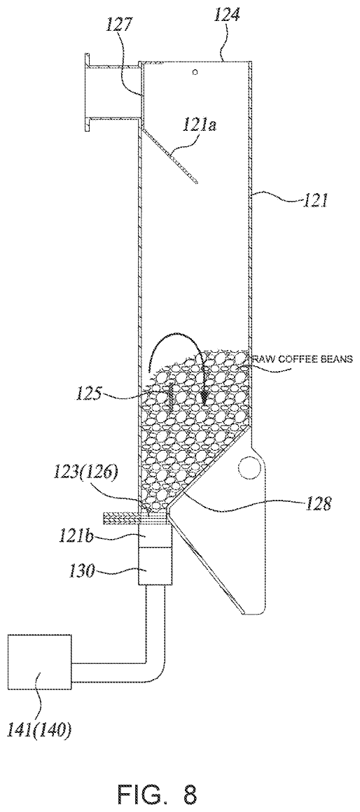

In addition, as shown in FIG. 8, it is preferable that, in the fluidizing chamber 120, a diffuser 121b communicating with the heating unit 130 is configured at the air inlet 123 at the lower end of the chamber body 121.

Thus, according to the fluidizing chamber 120, the inclined surface 122 is formed at the lower end of the chamber body 121 having the rectangular cylindrical body. A movement in which the raw coffee beans injected into the lower end of the inside of the chamber body 121 by the stirring plate 125 and the diffusion slot 126 configured in the air inlet 123 are moved upwards to a space between inner surfaces of the stirring plate 125 and the chamber body 121 from the lower end of the inclined surface 122 by heated air, and then dropped toward the inclined surface 122 of the chamber body 121 again, is repeatedly made. Thus, according to the embodiment of the present invention, the raw coffee beans are roasted in a fluidized method, so that the raw coffee beans do not burn, and taste and aroma can be improved.

Here, a distance from the other side of the chamber body 121 to the stirring plate 125 is preferably slightly greater than the diameter of the air inlet 123 in contact with the other side of the chamber body 121. Thus, as the air introduced through the air inlet 123 having a small area spread toward the upper part of the chamber body 121, the raw coffee beans are moved upward. In this case, the raw coffee beans moved to a higher position than the stirring plate 125 are repeatedly dropped to the inclined surface 122, so that the raw coffee beans are more smoothly fluidized.

In addition, preferably, the fluidizing chamber 120 is finished with a well-known insulating material in order to improve heat preservation.

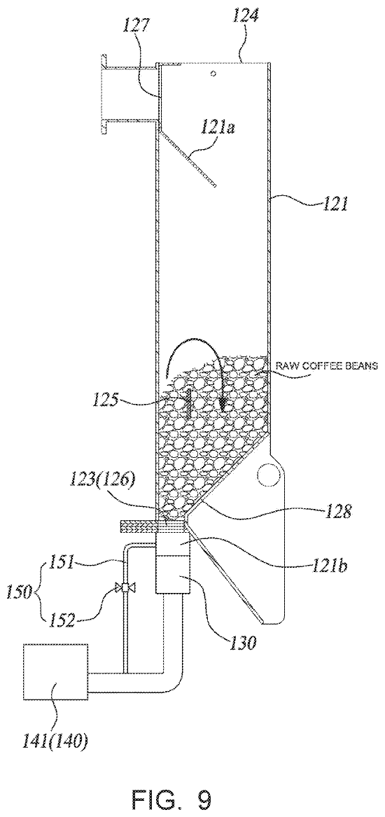

As illustrated in FIGS. 8-9, the heating unit 130 is a unit configured in the lower chamber 112 that communicates with the air inlet 123 of the lower end of the fluidizing chamber 120 so that the air introduced into the air inlet 123 is converted into heated air.

Here, preferably, the heating unit 130 is finished with a known heat insulating material in order to improve heat preservation.

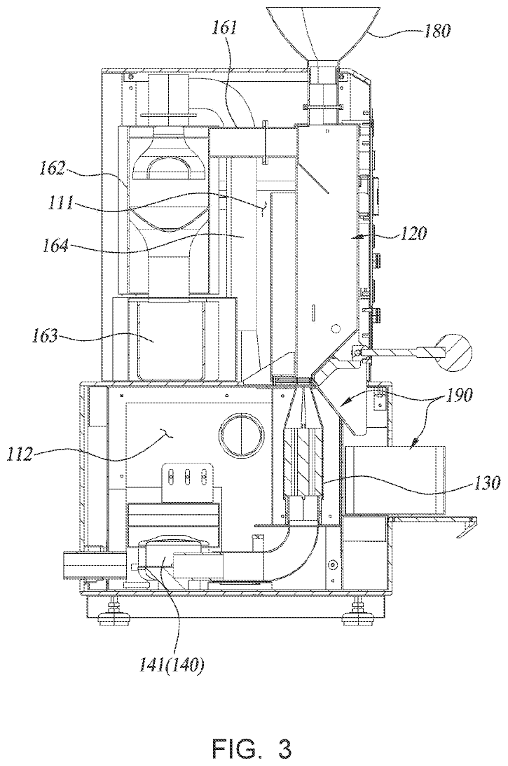

As shown in FIG. 3, the air supply unit 140 is located in the lower chamber 112 and is connected to the heating unit 130. The air supply unit 140 is an air supply unit in which when external air inside the lower chamber 112 is heated by the heating unit 130. The heated air is supplied to the lower end of the fluidizing chamber 120 and is discharged to the upper end of the fluidizing chamber 120 so that the raw coffee beans are circulated from the lower part of the fluidizing chamber 120 to the upper part of the fluidizing chamber 120 and are roasted. The air supply unit 140 includes an air supply fan 141 for supplying external air inside the lower chamber 112 to the heating unit 130 communicating with the air inlet 123 of the lower end of the fluidizing chamber 120.

Thus, according to the heating unit 130 and the air supply unit 140, a unit for supplying air and a unit for heating the air are simply coupled to each other in a state in which each of the unit for supplying air and the unit for heating the air has a modular configuration, so that installation and maintenance can be facilitated.

Here, preferably, a well-known noise suppresser for reducing driving noise is configured in the air supply fan 141, and for example, it is preferable to reduce the driving noise of the air supply fan 141 to 70 dB or less.

In FIG. 9, the flow auxiliary unit 150 is shown as an auxiliary flow unit, which is configured to be connected from the air supply unit 140 to the air inlet 123 of the lower end of the fluidizing chamber 120 and allows the external air inside the lower chamber 112 to be directly sprayed to the lower end of the fluidizing chamber 120 at a high speed so that when the raw coffee beans are heavy, the raw coffee beans flow together with the heated air. The flow auxiliary unit 150 includes a booster pipe 151 branching from a duct between the air supply fan 141 of the air supply unit 140 and the heating unit 130 to the air inlet 123 or the diffuser 121b of the fluidizing chamber 120, and an on/off valve 152 connected to the booster pipe 151 and electronically controlled.

Therefore, according to the flow auxiliary unit 150, when heated air through the heating unit 130 and the air supply unit 140 is introduced into the chamber body 121, the raw coffee beans are heavy, and fluidizing of the raw coffee beans is not done well during fluidizing roasting of the raw coffee beans, selectively, the external air can be sprayed directly to the air inlet 123 of the lower end of the chamber body 121 at a high speed. Thus, the roasting effect of heavy raw coffee beans can be improved by the flow auxiliary unit 150. In FIG. 2, the dust collecting unit 160 is illustrated as a dust collecting unit, which is located in the upper chamber 111, connected to the air outlet 127 of the upper end of the fluidizing chamber 120 and which collects foreign substances in the exhaust air discharged to the upper part of the fluidizing chamber 120. The dust collecting unit 160 includes an air outlet pipe 161 communicating with the air outlet 127 of the chamber body 121; a dust collector 162, which has a cylindrical structure and through which the air outlet pipe 161 is connected to the upper end of one side of the dust collector 162 and allows foreign substance having a high specific gravity to be dropped downwards when the exhaust air including the foreign substances is introduced; a foreign substance collector 163, which communicates with the lower part of the dust collector 162 and in which foreign substances are collected; and an air moving pipe 164, which extends from the upper end of the dust collector 162 to the heat exchanging unit 170 of the lower chamber 112 and allows only the exhaust air in which the foreign substances are dropped and removed from the dust collector 162, to be moved to the heat exchanging unit 170.

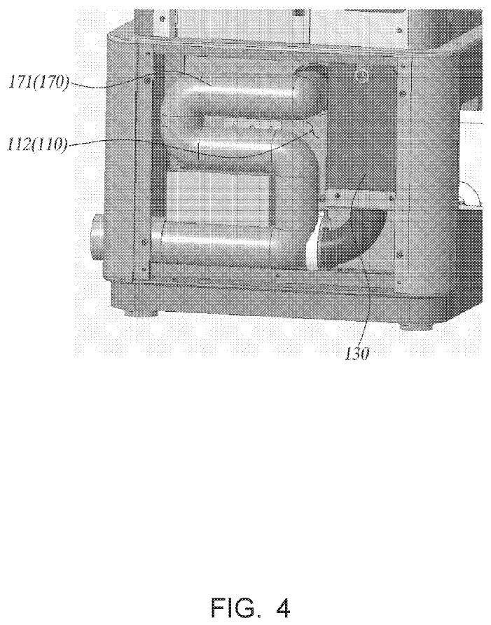

As shown in FIG. 4, the heat exchanging unit 170 is located in the lower chamber 112, and communicates with the dust collecting unit 160 and provides a discharge flow path through which the exhaust air from which foreign substances discharged from the dust collecting unit 160 are removed is discharged to the outside of the lower chamber 112. The heat exchanging unit 170 is a heat exchanging unit, which allows the external air of the lower chamber 112 to be heat-exchanged with the residual heat of the exhaust air, so that, when the heated air is supplied to the lower end of the fluidizing chamber 120 through the air supply unit 140, electrical energy consumption of the heating unit 130 can be saved. The heat exchanging unit 170 includes a corrugated pipe 171, which is located in the lower chamber 112 in a zigzag manner, has one end communicating with the air moving pipe 164 of the dust collecting unit 160 and allows the residual heat of the exhaust air moved from the dust collector 160 to be dispersed into the inner space of the lower chamber 112 and the external air inside the lower chamber 112 to be heat-exchanged at a predetermined temperature. An exhaust fan (not shown), which is connected to the other end of the corrugated pipe 171, allows the exhaust air to move through the fluidizing chamber 120, the dust collector 160 and the corrugated pipe 171 to be discharged to the outside.

Thus, according to the heat exchanging unit 170, the external air flowing into the inside of the fluting chamber 120 from the inside of the lower chamber 112 due to the residual heat of the heated air discharged to the outside of the fluidizing chamber 120 is heat-exchanged so that the electric energy of the heating unit 130 can be saved.

That is, according to the heat exchanging unit 170, when the external air at room temperature is required to be preheated to 70° C. to 80° C. and heated to 250° C. to 300° C. through the heating unit 130, electrical energy can be greatly saved.

In addition, preferably, the upper chamber 111 and the lower chamber 112 have a structure that is separated and sealed from each other through a partition wall. Thus, a greenhouse function provided to the lower chamber 112 by the heat exchanging unit 170 may be maximized.

The raw coffee bean injecting unit 180 is a raw coffee bean injecting unit, which is located outside the upper chamber 111, is connected to the upper end of the fluidizing chamber 120 and allows the raw coffee beans to be injected into the fluidizing chamber 120 from the outside.

As shown in FIGS. 1, 2 and 3, the coffee discharging unit 190 is a coffee discharging unit, which is configured in the lower chamber 112 and connected to the lower end of the fluidizing chamber 120 and allows roasted coffee to be discharged.

Hereinafter, the operation of the coffee roaster according to a preferred embodiment of the present invention will be described.

First, a predetermined amount of raw coffee beans is injected into the fluidizing chamber 120 through the raw coffee bean injecting unit 180.

Here, in the fluidizing chamber 120, as the inclined surface 122 is formed at the lower end of the chamber body 121, the density of raw coffee beans at the lower end of the chamber body 121 is higher than the density of raw coffee beans at the upper end of the inclined surface 122 of the chamber body 121.

Thereafter, heated air having a predetermined temperature is sprayed and introduced into the air inlet 123 of the lower end of the chamber body 121 by the air supply unit 140 and the heating unit 130.

Thereafter, a movement in which the raw coffee beans injected into the lower end of the inside of the chamber body 121 by the stirring plate 125 positioned on the inclined surface 122 of the chamber body 121 and the diffusion slot 126 configured in the air inlet 123, are moved upwards into a space between inner surfaces of the stirring plate 125 and the chamber body 121 from the lower end of the inclined surface 122 by the heated air and then dropped to the inclined surface 122 of the chamber body 121 again, is repeatedly made so that the raw coffee beans are roasted in a fluidized method and then discharged to the outside through the coffee discharging unit 190.

On the other hand, the heated air introduced into the lower end of the chamber body 121 is moved along the heat exchanging unit 170 of the lower chamber 112 including the air supply unit 140 and the heating unit 130 via the dust collecting unit 160 so that the external air in the lower chamber 112 is heat-exchanged to a predetermined temperature by residual heat of the exhaust air and the electric energy of the heating unit 130 can be saved when heating air is supplied to the chamber body 121.

In addition, as the flow auxiliary unit 150 is connected from the air supply unit 140 to the air inlet 123 of the lower end of the fluidizing chamber 120, the external air is directly sprayed into the lower end of the fluidizing chamber 120 at high speed, and even if the raw coffee beans are heavy, the fluidizing of the raw coffee beans can be improved and thus, the roasting effects can be improved.

Therefore, according to the above description, heated air is supplied and discharged from the lower part of the fluidizing chamber 120 having a cylindrical structure into which raw coffee beans are injected, to the upper part of the fluidizing chamber 120, and the raw coffee beans are circulated (fluidized) from the lower part to the upper part of the fluidizing chamber 120 and roasted, thereby roasting while maximizing the characteristics of the raw coffee beans without burning the raw coffee beans.

In addition, the fluidity of the raw coffee beans is maintained even when the raw coffee beans are heavy by high-speed spraying of external air through the flow auxiliary unit 150 into the lower part of the fluidizing chamber 120, thereby maximizing fluidized roasting.

In addition, the external air supplied to the fluidizing chamber 120 through the heat exchanging unit 170 is heat-exchanged with the heated air discharged from the fluidizing chamber 120 so that the electrical energy of the heating unit 130 can be saved.

Accordingly, according to the present invention, heated air is supplied and discharged from a lower part of a fluidizing chamber to an upper part of the fluidizing chamber having a cylindrical structure in which raw coffee beans are injected and the raw coffee beans are circulated (fluidized) from the lower part of the fluidizing chamber to the upper part of the fluidizing chamber and roasted, thereby enabling roasting that maximizes the characteristics of the raw coffee beans while the raw coffee beans do not burn.

In addition, external air is sprayed into the lower part of the fluidizing chamber at a high speed so that the fluidity of the raw coffee beans is maintained even when the raw coffee beans are heavy, thereby enabling fluidized roasting.

In addition, external air in which heated air discharged to the upper part of the fluidizing chamber is supplied to the lower part of the fluidizing chamber, is preheated so that the electric energy of a heating unit can be saved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A fluidized electric coffee roaster comprising:
a housing;
a fluidizing chamber having a predetermined volume into which raw coffee beans are introduced, discharged, and roasted;
a heating unit communicating with a lower end of the fluidizing chamber;
an air supply unit connected to the heating unit and supplying external air inside the housing to the heating unit;
a raw coffee bean injecting unit connected to an upper end of the fluidizing chamber and allowing raw coffee beans to be injected into the fluidizing chamber from an outside; and
a coffee discharging unit connected to a lower end of the fluidizing chamber and allowing roasted coffee to be discharged,
wherein air heated by the heating unit is supplied to the lower end of the fluidizing chamber and is discharged to an upper end of the fluidizing chamber so that the raw coffee beans are circulated from a lower part of the fluidizing chamber to an upper part of the fluidizing chamber and roasted.

2. The fluidized electric coffee roaster of claim 1, further comprising a flow auxiliary unit that is configured to be connected from the air supply unit to the lower end of the fluidizing chamber and allows external air to be directly supplied to the lower end of the fluidizing chamber and raw coffee beans, thereby flowing the raw coffee beans.

3. The fluidized electric coffee roaster of claim 1, further comprising:
a dust collecting unit connected to the upper end of the fluidizing chamber and collecting foreign substance in exhaust air discharged to an upper part of the fluidizing chamber; and
a heat exchanging unit communicating with the dust collecting unit and providing a discharge flow path through which the exhaust air from which the foreign substances discharged from the dust collecting unit are removed, is discharged to the outside,
wherein the heat exchanging unit allows external air inside the housing to be heat-exchanged by residual heat of the air discharged through the discharge flow path and then to be supplied to the lower end of the fluidizing chamber through the air supply unit.

4. The fluidized electric coffee roaster of claim 1, wherein the fluidizing chamber comprises:
a chamber body having a rectangular cylindrical shape;
an inclined surface configured such a way that one side of a lower end of the chamber body is inclined toward the other side of the lower end of the chamber body;
an air inlet, which is opened at the lower end of the chamber body with a cross-sectional area of a smaller size than the cross-sectional area of the chamber body and into which heated air is introduced from the air supply unit;
a raw coffee bean inlet, which is opened at the upper end of the chamber body and through which raw coffee beans are introduced into the chamber body from the raw coffee bean injecting unit;
a stirring plate, which is formed in a position spaced apart from the other side of the chamber body and into which heated air is introduced through the air inlet so that, when the raw coffee beans injected into the vicinity of the inclined surface of the chamber body are fluidized, an agitation layer of the raw coffee beans stacked inside the lower end of the chamber body does not collapse;
a diffusion slot, which is located in the air inlet and in which heated air flowing into the lower end of the chamber body through the air inlet is diffused into the interior of the chamber body and simultaneously straightness is maintained;
an air outlet, which is opened at one side of the upper end of the chamber body and in which heated air introduced into the chamber body is discharged to the dust collecting unit; and
a coffee outlet, which is formed to extend to an opening formed in the lower part of the inclined surface at a predetermined angle and through which coffee roasted in the chamber body is discharged to the outside.

5. The fluidized electric coffee roaster of claim 2, wherein the flow auxiliary unit comprises:
a booster pipe branching from a duct between the air supply fan of the air supply unit and the heating unit to the air inlet of the fluidizing chamber; and
an on/off valve connected to the booster pipe and controlled.

6. The fluidized electric coffee roaster of claim 3, wherein the dust collecting unit comprises:
an air outlet pipe communicating with the fluidizing chamber;
a dust collector, which has a cylindrical structure and through which the air outlet pipe is connected to the upper end of one side of the dust collector and allows foreign substance having a high specific gravity to be dropped downwards when the exhaust air including the foreign substances is introduced; and
an air moving pipe, which extends from the upper end of the dust collector to the heat exchanging unit and allows the exhaust air to be moved from the dust collector to the heat exchanging unit.

7. The fluidized electric coffee roaster of claim 6, wherein the heat exchanging unit comprises:
a corrugated pipe, which is located in the lower chamber in a zigzag manner and has one end communicating with the air moving pipe of the dust collecting unit and allows the residual heat of the exhaust air to be dispersed into the inner space of the housing and the external air inside the housing to be heat-exchanged; and
an exhaust fan, which is connected to the other end of the corrugated pipe and allows the exhaust air moved through the fluidizing chamber, the dust collector and the corrugated pipe to be discharged to the outside.
